(19) United States
(12) Patent Application Publication
(10) Pub. No.: US 2012/0168676 A1
(43) Pub. Date: Jul. 5, 2012

(54) Acceleration of particles beyond the speed of light and applications

(76) Inventor: Olivier Jean-Marie / Rene Gorre, Sceaux (FR)

(21) Appl. No.: 12/983,293

(22) Filed: Jan. 1, 2011

(51) Int. Cl. C09K 3/00

(52) U.S. Cl. 252/182.11

(57) ABSTRACT

With my device, I can accelerate in void particles of matter beyond the speed of light thanks to particles, antiparticles of antimatter and electromagnetic or electrostatic field.

I can produce energy in a void electromagnetic or electrostatic circuit thanks to properties of superluminal particles since electromagnetic fields produced by superluminal particles are always behind them. So they can heat “black” or “dark” material according to fields produced by them without decelerate at all.

I can also produce hypersensitive electromagnetic or electrostatic sensors since superluminal particles doesn't have inertia.

I think that it is possible to accelerate particles beyond the speed of light. They are called superluminal particles.

In this objective, we annihilate and collide in front of the moving particle to accelerate in void an antiparticle and another same type of particle (Drawings FIG. 1).

The speeds are well tuned not to produce new particles or antiparticles. Speeds are as high as possible. An acceleration electromagnetic or electrostatic field (constant or impulse) can also be used at the point of annihilation and collision for more acceleration.

For industrial applications, it's possible to use particles' and antiparticles' beams in the aim to increase productivity.

Density (pressure) of beams' particles or antiparticles can vary according to beams' speed.

Superluminal particles have all their electromagnetic and electrostatic fields behind them since they move faster than the speed of light. I use this property to produce energy.

They move in an electromagnetic or electrostatic circuit in void. If the radiations of superluminal particles encounter “black” or “dark” material (not “white” or “transparent”), this material will heat since radiations are absorbed by the material.

If, during one revolution of superluminal particles in the circuit, all the radiations emitted are absorbed by material, the superluminal particles will not be decelerated. Because of imperfections of the circuit, superluminal particles can be decelerated a little. But they need very few electromagnetic or electrostatic energy to be accelerated since they have no inertia.

So, the Return Of Investment (ROI) of such a device is positive regards energy, matter and work costs' considerations. It also produces more energy that it consumes.

For industrial applications, it is possible to use beams' particles of a determined density (pressure) in the aim to increase productivity.

It is possible for industrial purposes to have circuit material like a sandwich of “transparent”, “dark”, “black” layers of material.

I can also produce hypersensitive electromagnetic or electrostatic sensors with superluminal particles. I use the property of superluminal particles not to have inertia. So, they can move and react freely according to electromagnetic or electrostatic signals to detect.

They moves in a void “black” electromagnetic or electrostatic circuit. Signals enter throw a “transparent” window in the circuit for signals considered in front of moving superluminal particles (Drawings FIG. 2).

Since superluminal particles react very freely to electromagnetic or electrostatic signals, I just need to detect voltage differences in time thanks to metallic plates or magnetic coils after the superluminal particles' passage. Like this, I can transform electromagnetic or electrostatic signals into voltage differences and compute them for analysis.

For industrial applications it is possible to use beams' particles of a determined density (pressure) in the aim to increase productivity or sensitivity of superluminal sensors.

### BRIEF DESCRIPTION OF THE FIGURES

FIG. 1. The figure shows 2 particles and 1 antiparticle that collide, annihilate and accelerate in void. In this process speeds are maximum and don't produce new types of particles. An electromagnetic or electrostatic acceleration constant field or impulse help the process of acceleration.

FIG. 2. The figure shows a superluminal particles' beam in void passing in front of a transparent window according to electromagnetic or electrostatic waves to observe. Metallic plates, coils or captors (in general) near the particles' beam can achieve the detection of very small electromagnetic or electrostatic signals that move the superluminal beam since it hasn't got any inertia.

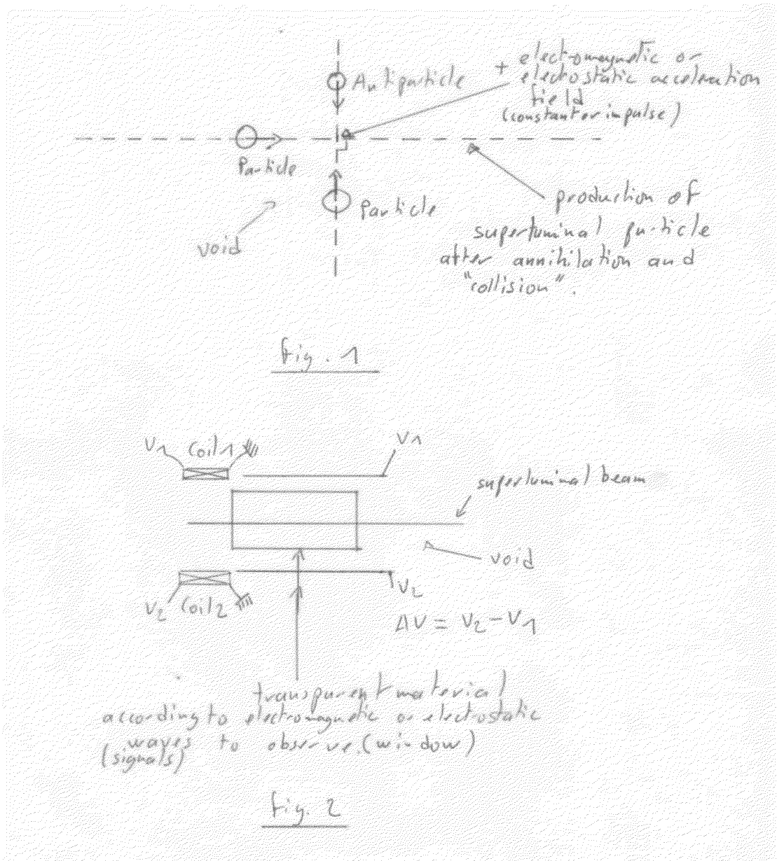

1) Production of superluminal particles thanks to antiparticles of the particles to accelerate, other same type of particles and an acceleration electromagnetic or electrostatic field (constant or impulse). For industrial applications, particles' beams of a determined density (pressure) are used instead of single particles or antiparticles. Beams' speeds are as high as possible not to produce new particles or antiparticles.

2) Energy production with superluminal particles that heat a “black” or “dark” material thanks to electromagnetic or electrostatic fields produced by them in an electromagnetic or electrostatic void circuit. For industrial applications, particles' beams of a determined density (pressure) are used instead of single particles.

3) Production of hypersensitive electromagnetic or electrostatic sensors because of lack of inertia of superluminal particles in an electromagnetic or electrostatic void circuit. For industrial applications, particles' beams of a determined density (pressure) are used instead of single particles.
